(19) United States
(12) Patent Application Publication
(10) Pub. No.: US 2005/0209736 A1
(43) Pub. Date: Sep. 22, 2005

(54) Self-propelled working robot

(75) Inventor: Nobukazu Kawagoe, Tokyo (JP)

Correspondence Address: BIRCH STEWART KOLASCH & BIRCH, PO BOX 747, FALLS CHURCH, VA, 22040-0747, US

(73) Assignee: FIGLA CO., LTD.

(21) Appl. No.: 11/116,296

(22) Filed: Apr. 28, 2005

Related U.S. Application Data
(63) Continuation-in-part of application No. PCT/JP03/13392, filed on Oct. 20, 2003.

(30) Foreign Application Priority Data
Nov. 13, 2002 (JP) 2002-364428
Aug. 22, 2003 (JP) 2003-298193
May 7, 2004 (JP) 2004-137997

(51) Int. Cl. G06F 19/00

(52) U.S. Cl. 700/245

(57) ABSTRACT

A self-propelled working robot according to the present invention comprises a traveling assembly (1) having a wheel (6) and first and second working assemblies (20, 50) that are detachable from the traveling assembly 81). One of the first and second working assemblies (20, 50) is selectively mounted on the traveling assembly (1). Each working assembly has a type identification means (33) that enables identification of a type of the working assembly. The traveling assembly (1) has a driving motor (5) that drives the wheel (6), a wheel controlling means (41) that controls rotation of the driving motor (5), a discriminating means (38) that discriminates which of the working assemblies is mounted and a work signal output means (39) that outputs a work signal for actuating the working assembly (20, 50) in response to a result of a discrimination.

### CROSS-REFERENCE TO RELATED APPLICATIONS

This application is a continuation in part of the PCT international application No. PCT/JP2003/013392 filed on Oct. 20, 2003, which claims the priorities on Japanese patent application number 2002-364428, filed in Japan on Nov. 13, 2002, and Japanese patent application number 2003-298193, filed in Japan on Aug. 22, 2003, and this application claims the priority of Japanese patent application number 2004-137997, filed in Japan on May 7, 2004. The entire contents of all these applications are hereby incorporated herein by reference.

### BACKGROUND OF THE INVENTION

1. Field of the Invention

The present invention relates to a self-propelled working robot, in particular, a self-propelled working robot capable of performing plural types of operations with respect to a floor.

2. Background Art

Conventionally, self-propelled working robots have been known in, for example, the following document.

The first non-patent document: Nobukazu Kawagoe and other one (1997), “Portable Automatic Moving Robot” in Human With Technology (HWT), 1997 September issue, pp. 25-35.

The working robot of the first non-patented document has a traveling means such as a wheel and a scanning means such as a drop nozzle. The working robot travels while scanning the floor with the drop nozzle, thereby to apply liquid such as antiseptic solution and wax to the floor. A working assembly, which is supported movably in the width direction of a working region, is connected to a rear part of the working robot, and the liquid such as wax dropped from the nozzle is applied and spread by using an applying and spreading means provided at an end of the working assembly.

This working robot is used with either of two different working parts for applying antiseptic solution and for applying wax attached to the working robot with a common autonomous traveling vehicle, depending on the case. However, the working robot is mechanically configured so that the user cannot replace easily the working parts with each other and therefore this requires disassembly or assembly by use of tools such as a driver. Further, since a control part does not have any means for identifying the type of the working part and a separate program is stored in the control part of each robot, the user cannot easily replace the working part with a different type of working part and use it.

Moreover, the working robot is configured so that a compact tank for storing liquid having a capacity of about 1 liter is inserted from above into a recessed part provided on a part of a upper surface of the traveling means, and the state where the tank is mounted forms an external appearance of the working robot. Accordingly, in terms of design, only a component of fixed size and form can be mounted on the working robot.

For example, in the case of assigning a suction and cleaning function to the working robot, as the tank for storing liquid becomes unnecessary, it is rational to mount a dust-collecting box part having a motor, a filter, a dust collecting part, a battery and so on of a suction and cleaning assembly, instead of the tank, on the autonomous traveling vehicle. These parts need not be disposed in the vicinity of the floor and are relatively heavy in weight. It is difficult to make the tank for storing liquid and the dust-collecting box part of the same shape, and to obtain an external appearance of uniform design.

Accordingly, an object of the present invention is to provide a self-propelled working robot wherein plural types of working assemblies, each of which has a separate function, can be easily replaced with each other and various operations with respect to the floor can be performed.

Another object of the present invention is to obtain an external appearance of uniform design even if any working assembly is mounted on the traveling assembly.

Yet another object of the present invention is to provide a self-propelled working robot wherein deterioration of the quality of work can be prevented by optimizing automatically traveling action of the working robot in accordance with types (works) of working assemblies.

### SUMMARY OF THE INVENTION

In order to achieve above-mentioned objects, a self-propelled working robot according to the present invention comprises a traveling assembly having a wheel and self-propelled on a floor, a first working assembly that performs a first operation with respect to the floor and is detachable from the traveling assembly and a second working assembly that performs a second operation with respect to the floor and is detachable from the traveling assembly. Either the first working assembly or the second working assembly is selectively mounted on the traveling assembly. Each working assembly has a type identification means that enables identification of a type of the working assembly when mounted on the traveling assembly. The traveling assembly has a driving motor that drives the wheel, a wheel controlling means that controls rotation of the driving motor, a discriminating means that discriminates which of the working assemblies is mounted and a work signal output means that outputs a work signal for actuating the mounted working assembly according to the type of the mounted working assembly in response to a result of a discrimination of the discriminating means.

According to the present invention, since either the first working assembly or the second working assembly can be selectively mounted on one traveling assembly and controlling method of the working assembly is automatically selected according to the type of the selected working assembly, the robot can be easily used to cope with various operations with respect to the floor.

Further, since one traveling assembly can be used efficiently, costs can be reduced.

In a preferred aspect of the invention, the type identification means outputs an electrical signal to the discriminating means.

In this aspect, the configuration becomes simpler than the case where the type of the working assembly is discriminated through the use of a physical method. Further, a new type of the working assembly can be easily discriminated, merely by changing program.

In another preferred aspect of the present invention, each working assembly is equipped with a control board that controls operation of the working assembly based on the work signal from the traveling assembly.

In this aspect, it becomes unnecessary to equip control means (control boards, programs and so on) corresponding to each of the working assembly with the traveling assembly, and so the configuration of the traveling assembly can be simplified. Further, since it is unnecessary to change the configuration of the traveling assembly even in the case where a new working assembly is applied, a versatile working robot can be achieved.

In another preferred aspect of the present invention, the traveling assembly is a carriage supported by the wheel. Each working assembly comprises a side unit that is attached to a fore side or a rear side of the carriage, a top unit including a tank mounted on a top surface of the carriage and a tube that connects both units with each other. The side unit is located in proximity to or in contact with the floor.

In this aspect, the working assembly has the side unit performing an operation directly to the floor and the top unit including an element which need not be located near the floor, separately. By arranging the top unit, which is relatively heavy in weight, on the carriage, stability at the time of traveling of the robot can be improved. Accordingly, the robot can reliably perform a operation with respect to the floor.

In a more preferred aspect of the present invention, a cover is detachably provided so as to cover the top unit, which is located on the upper side of the working assembly, in a state where the top unit is mounted on the traveling assembly.

In this aspect, an external appearance of uniform design can be obtained independently of a type of working assembly mounted on the traveling assembly. Further, since the cover is provided detachably, when reduction in size and weight is considered more important than the external appearance, the reduction in size and weight can be realized by using the robot with the cover removed. Further, since the cover can be easily attached and detached, maintenance can be easily performed.

A self-propelled according to another aspect of the present invention, comprises a traveling assembly having a wheel and self-propelled on a floor, a first working assembly that performs a first operation with respect to the floor and is detachable from the traveling assembly and a second working assembly that performs a second operation with respect to the floor and is detachable from the traveling assembly. Either the first working assembly or the second working assembly is selectively mounted on the traveling assembly. The traveling assembly comprises a driving motor for driving the wheel; a plurality of detecting means that detects a obstacle; a recognizing means that recognizes a state of the obstacle, based on an output from the detecting means; a determining means that determines a path where the working robot travels, according to the type of the mounted working assembly and the state of the obstacle recognized by the recognizing means; and a wheel controlling means that controls rotation of the driving motor so that the working robot travels along the path determined by the determining means.

In this aspect, since either the first working assembly or the second working assembly can be selectively mounted on one traveling assembly and the path along which the working robot travels is automatically determined according to the type of the selected working assembly and the state of the obstacle, the working robot can perform various operations with respect to the floor.

In this case, it is preferred that, when the working robot performs the first operation, the determining means determines the path so that the wheel does not substantially pass on an area of the floor where the first operation has already been performed and, when the working robot performs the second operation, the determining means determines the path so that the second operation can be performed at an edge area of the floor with the wheel allowed to pass on an area of the floor where the second operation has already been performed.

According to this preferred aspect, for example, in the case where the first operation performed by the first working assembly is to apply liquid such as wax onto the floor face and the second operation performed by the second working operation is to clean the floor by sucking dusts on the floor, the first operation can be performed so that wheel ruts may not be formed on the floor face where the liquid such as wax is applied and the second operation can be performed without leaving dust at the edge area including a corner of the floor and an edge of the floor beside a wall.

### BRIEF DESCRIPTION OF THE DRAWINGS

The present invention will be understood more apparently from the following description of preferred embodiment when taken in conjunction with the accompanying drawings. However, it will be appreciated that the embodiments and the drawings are given for the purpose of mere illustration and explanation and should not be utilized to define the scope of the present invention. The scope of the present invention is to be defined only by the appended claims. In the drawings annexed, the same reference numerals denote the same or corresponding parts throughout several views.

FIG. 1 is a plan view and a side view showing the configuration of a traveling assembly of a working robot according to the present invention.

FIG. 2 is a side view showing the state where a liquid applying assembly and the traveling assembly of a first embodiment are separated from each other.

FIG. 3 is a side view showing the state where the liquid applying assembly is mounted on the traveling assembly.

FIG. 4 is a plan view of the working robot of the first embodiment seen from above.

FIG. 5(a) is a block diagram showing connection relation with respect to electrical signals between a control board of the liquid applying assembly and a control part of the traveling assembly and

FIG. 5(b) is a chart showing a setting example of an identifying signal.

FIG. 6 is a side view showing the state where a sucking and cleaning assembly and the traveling assembly of a second embodiment are separated from each other.

FIG. 7 is a side view showing the state where the sucking and cleaning assembly is mounted on the traveling assembly.

FIG. 8 is a plan view of the working robot of the second embodiment seen from above.

FIG. 9 is a block diagram showing connection relation with respect to electrical signals between a control board of the sucking and cleaning assembly and the control part of the traveling assembly.

FIG. 10 is a side view, partially in section, showing the state where a cover is attached to the traveling assembly with the liquid applying assembly being mounted thereon.

FIG. 11 is a side view, partially in section, showing the state where a cover is attached to the traveling assembly with the sucking and cleaning assembly being mounted thereon.

FIG. 12 is a side view, partially in section, showing opening and closing of a top cover.

FIG. 13 is a side view, partially in section, showing opening and closing of the cover.

FIG. 14 is a perspective view showing the state where the cover is attached.

FIG. 15 is a perspective view showing the state where the cover is attached.

FIG. 16 is a plan view showing a path where the working robot travels when performing sucking and cleaning operation with the sucking and cleaning assembly.

FIG. 17 is a plan view showing a path where the working robot travels when performing liquid applying operation with the liquid applying assembly.

FIG. 19 is a plan view showing a path where the working robot travels when performing radiation operation with the radiation assembly.

FIG. 20A is a plan view showing a path where the working robot travels when sucking and cleaning and

FIG. 20B is a plan view showing a path where the working robot travels when applying liquid.

### DESCRIPTION OF THE PREFERRED EMBODIMENTS

### First Embodiment

Referring to appended figures, a first embodiment of the present invention will be described below.

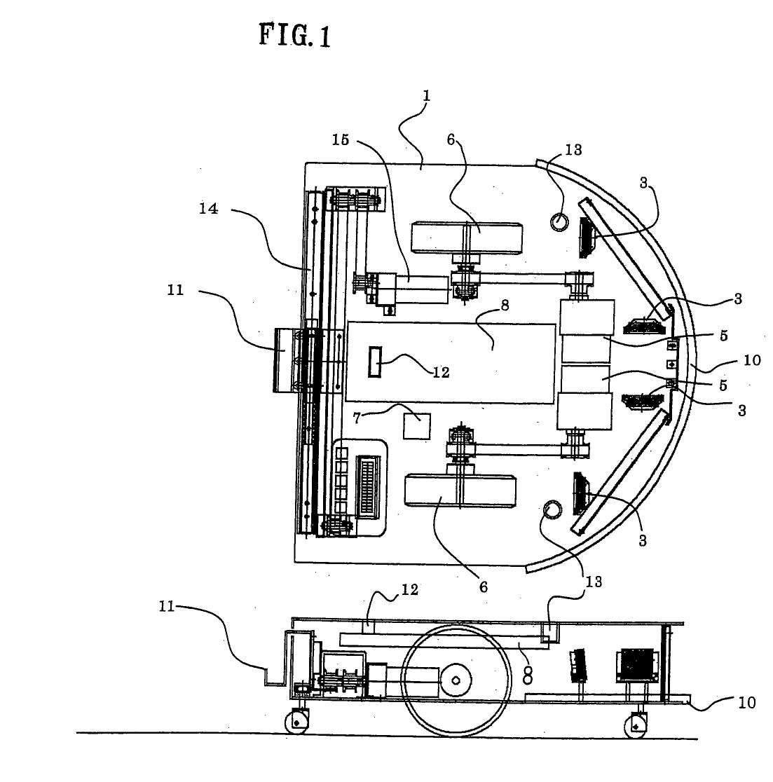

A working robot of this embodiment has a traveling assembly 1 shown in FIG. 1 as a common configuration and is used after selectively mounting one of various working assemblies on the traveling assembly 1. This first embodiment is described by taking an example where a liquid applying assembly 20 is mounted as a first working assembly.

As shown in FIG. 1, a working robot according to the present invention has the traveling assembly 1 shaped like a carriage that travels automatically on the floor. A pair of wheels 6 are provided, each on the right and left sides of the traveling assembly 1. The wheels 6 are driven by driving motors 5. The rotational speed of the driving motors 5 is controlled by a control part 8.

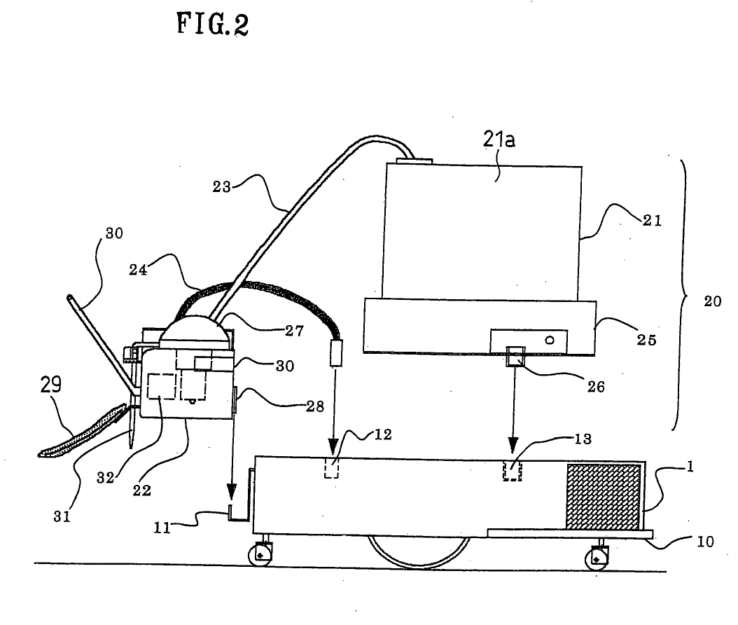

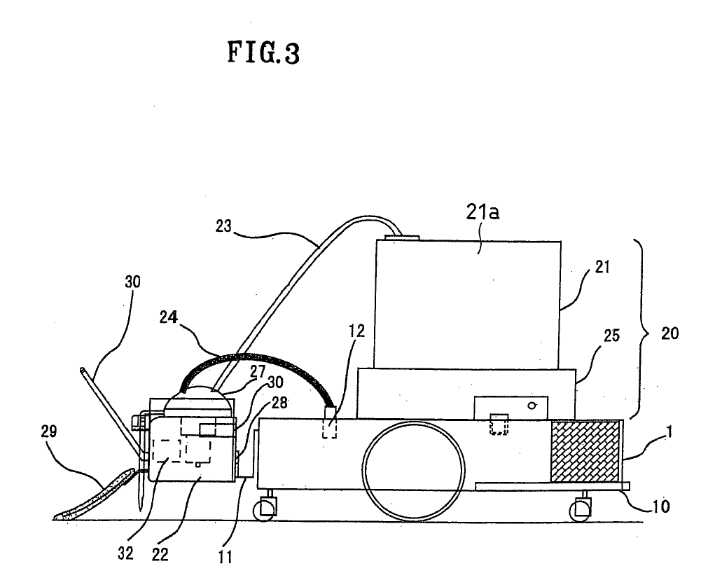

As shown in FIG. 2, the liquid applying assembly 20 has a top unit 21 and a side unit 22. Each of the units 21 and 22 is configured so that they can be attached to and detached from the traveling assembly 1.

A top surface of the traveling assembly 1 is a substantially flat surface that enables various devices to be easily mounted thereon. A socket 13 of a cam-lock fastener is provided on the top surface of the traveling assembly 1 and a plug 26 of the cam-lock fastener is provided on the bottom surface of the top unit 21. By inserting the plug 26 into the socket 13, the top unit 21 is fixed at a given location.

An attachment plate 11 for attaching the side unit 22 of the liquid applying assembly 20 is provided at the rear part of the traveling assembly 1. The attachment plate 11 is a hook like metal fitting. By engaging an attachment metal fitting 28, which is provided with the side unit 22, with the attachment plate 11, the side unit 22 is attached to the rear part of the traveling assembly 1.

As shown in FIG. 1, the attachment plate 11 is attached to a slide rail 14 and connected with a slide driving motor 15 for driving a slide through a timing belt and a pulley. The attachment plate 11 slides to move from side to side along the slide rail 14 by the driving motor 15.

As shown in FIG. 1, the traveling assembly 1 has an ultrasonic range finding sensor 3, a gyro sensor 7, a bumper sensor 10 and a control part 8. A power supply (not shown), which supplies electric power to the traveling assembly 1 and the liquid applying assembly 20, is also detachably provided with the traveling assembly 1.

Control Part:

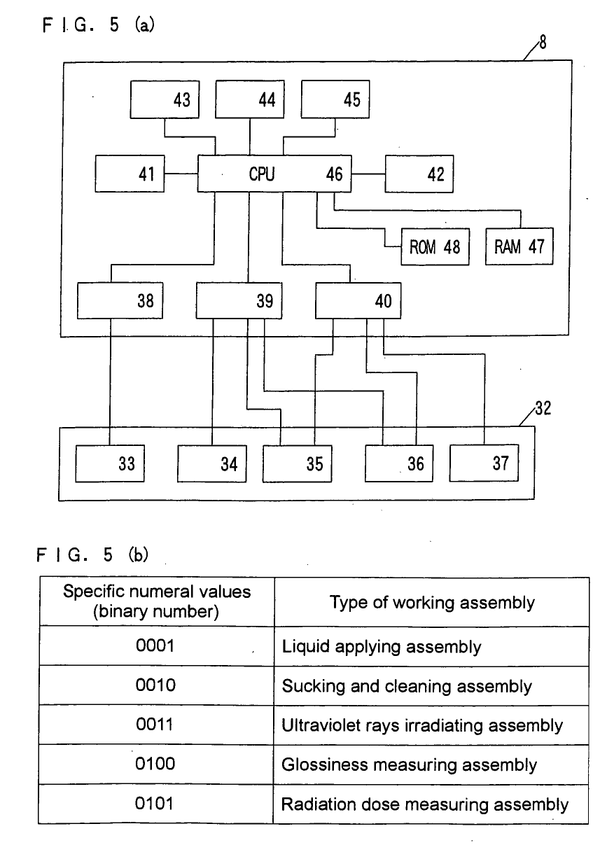

As shown in FIG. 5(a), the control part 8 comprises a discriminating means 38, a work signal output means 39, a sensor signal (reading) input means 40, a wheel controlling means 41, a slide control means 42, an ultrasonic sensor control means 43, a gyro sensor control means 44, a bumper sensor control means 45, CPU 46, RAM 47 and ROM 48.

The means 38 to 45 and the CPU 46 are connected with each other through an interface (not shown).

As shown in FIG. 1, a connector 12 is provided with the control part 8. The control part 8 is electrically connected with a control board 32 provided in the liquid applying assembly 20 through a cable 24 shown in FIG. 2. The control part 8 receives information from a type identification means 33 of the control board 32 as an input, and discriminate a type of the working assembly by discriminating means 38. Then, the control part 8 controls a work signal output means 39 so that the work signal output means 39 outputs a work signal for activating the working assembly in accordance with the type of the working assembly.

A pump control means 34, a scan control means 35 and an ascent and descent control means 36, which will be described below, are equipped with the control board 32. The work signal output means outputs work signals to each of control means 34, 35 and 36.

The touch sensor control means 37, which will be described below, is also equipped with the control board 32. The sensor signal input means 40 outputs signals from each of the above control means 35, 36 and 37 to the CPU 46.

The wheel controlling means 41 controls the rotation of the driving motors 5. That is, the wheel controlling means 41 controls the rotational speed of the wheel 6 in accordance with the distance from the obstacle and the travel direction, which are measured by the CPU 46 based on signals from sensors such as the ultrasonic range finding sensor 3, the gyro sensor 7 and the bumper sensor 10.

The slide control means 42 controls the rotation of the slide driving motor 15 so as to control the slide from side to side of the attachment plate 11.

The sensor control means 43, 44 and 45 control the ultrasonic range finding sensor 3, the gyro sensor 7 and the bumper sensor 10, respectively.

The CPU 46 controls the wheel control means 41 and the slide control means 42 in accordance with programs stored in ROM 48 and information of work orders stored in RAM 47 and in response to information from the discriminating means 38, the sensor signal input means 40, the wheel controlling means 41, the slide control means 42, the ultrasonic sensor control means 43, the gyro sensor control means 44 and the bumper sensor control means 45. And the CPU 46 controls the work signal output means 39 so that the work signal output means 39 outputs a work signal to the liquid applying assembly 20.

The RAM 47 is a random access memory for storing information (data) of work orders such as work area and work plan and storing various control variables. The ROM 48 is a read only memory for storing programs.

First Working Assembly:

As shown in FIG. 2, the liquid applying assembly 20 is a working assembly for applying liquid such as wax and antiseptic solution on the floor face uniformly. The liquid applying assembly has the top unit 21, which is a part relatively heavy in weight and need not be located near the floor, and the side unit 22, which applies liquid on the floor face uniformly. The top unit 21 and the side unit 22 are connected with each other by a tube 23 for supplying liquid.

The top unit 21 has a tank holder 25 and a tank 21a which is detachably mounted thereon. The tank 21a stores liquid.

The side unit 22 has a nozzle (applying part) 31 and a pump 27. The pump 27 supplies the nozzle 31 with the liquid stored in the tank 21a through the tube 23 for supplying liquid. The nozzle 31 drops the liquid quantitatively onto the floor face. The nozzle 31 is moved scanning from side to side at a given speed (for example, one reciprocation per one or two seconds) by a motor (not shown) while traveling forward so that the nozzle 31 drops zigzag the liquid onto the floor. The liquid dropped onto the floor is spread uniformly by a cloth (spreading part) 29 for spreading liquid.

The cloth 29 for spreading liquid is driven to ascend and descend by a motor (not shown). That is, the cloth 29 is in touch with the floor by descent when the liquid is applied and is off from the floor by ascent when the robot travels without applying liquid.

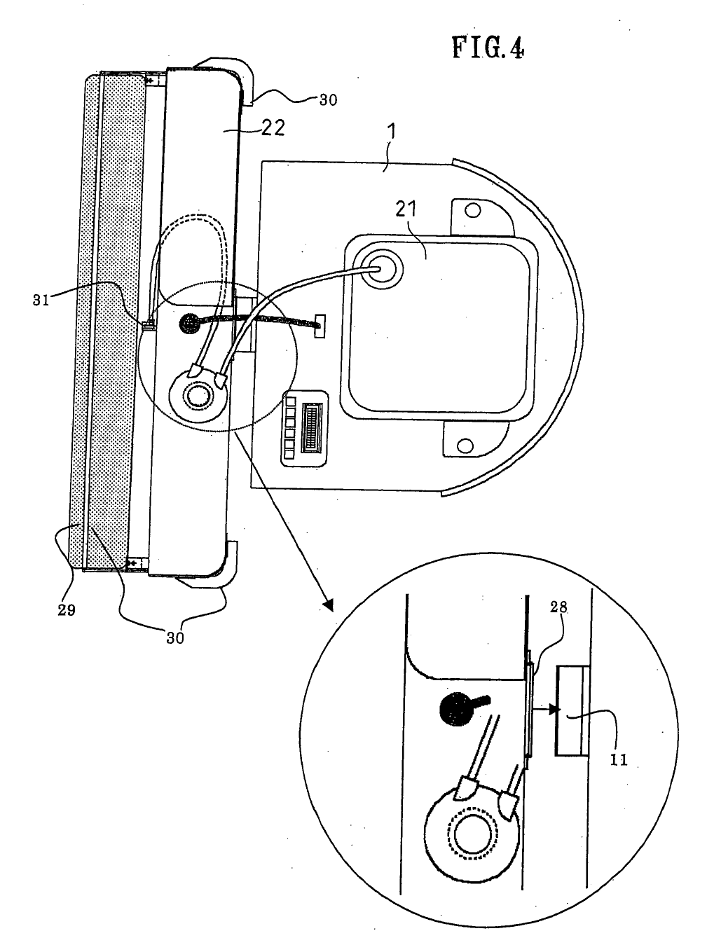

The method of attaching the liquid applying assembly 20 is described below.
(1) putting the tank holder 25 on the traveling assembly 1 and fixing the tank holder 25 thereon with the plug 26 and the socket 13 of the cam-lock fastener
(2) putting the tank 21a on the tank holder 25
(3) connecting mechanically the side unit 22 with the traveling assembly 1, by inserting the attachment fitting 28 of the side unit 22 into the attachment plate 11 of the traveling assembly 1 (FIG. 4)
(4) connecting electrically the side unit 22 with the traveling assembly 1, by connecting one end of the cable 24, the other end of which is connected with the control board 32 of the side unit 22, with the connector 12 of the traveling assembly 1
(5) inserting the tube 23, which is connected with the pump 27 of the side unit 22, into the tank 21a.

Since the side unit 22 is attached to the slidable attachment plate 11, the side unit 22 can slide from side to side, controlled by the control part 8. The length of the cable 24 and the length of the tube 23 for supplying liquid are set within such a range that the side unit 22 can slide from side to side.

As shown in FIG. 4, touch sensors 30 are provided at the right and left side edges and at the rear side of the side unit 22, respectively. The sensing state of the touch sensors 30 is input into the control part 8 and fed back into the slide control of the side unit 22 and traveling control.

As shown in FIG. 2, the control board 32 is equipped with the side unit 22. As shown in FIG. 5(a), the control board 32 has the type identification means 33, the pump control means 34, the scan control means 35 and the ascent and descent control means 36 and the touch sensor control means 37.

The type identification means 33 outputs a numeral value which indicates a type of the working assembly. As shown in FIG. 5(b), specific numeral values are preliminarily set and stored in association with each of the working assemblies.

As a method of storing set values, for example, setting by a DIP switch may be used or writing set values in a semiconductor memory such as a flash memory may be used.

The pump control means 34 controls driving of the pump 27 on the basis of a work signal from the work signal output means 39 of the control part 8.

The scan control means 35 controls scan driving of the nozzle 31 from side to side on the basis of a work signal from the work signal output means 39. Further, the scan control means 35 detects the nozzle 31 arriving at the right or left side edge, for example, by photo interrupter (not shown), and outputs an edge arrival signal to the sensor signal input means 40 of the control part 8.

The ascent and descent control means 36 controls driving of ascent and descent of the cloth 29 for spreading liquid on the basis of a work signal from the work signal output means 39. Further, the ascent and descent control means 36 detects the position of the cloth 29 by a position detection sensor in which, for example, photo interrupter or microswitch (not shown) is used and outputs a detection signal to the sensor signal input means 40.

The touch sensor control means 37 detects the ON/OFF state of the touch sensor 30, and outputs a detection signal to the sensor signal input means 40.

### Second Embodiment

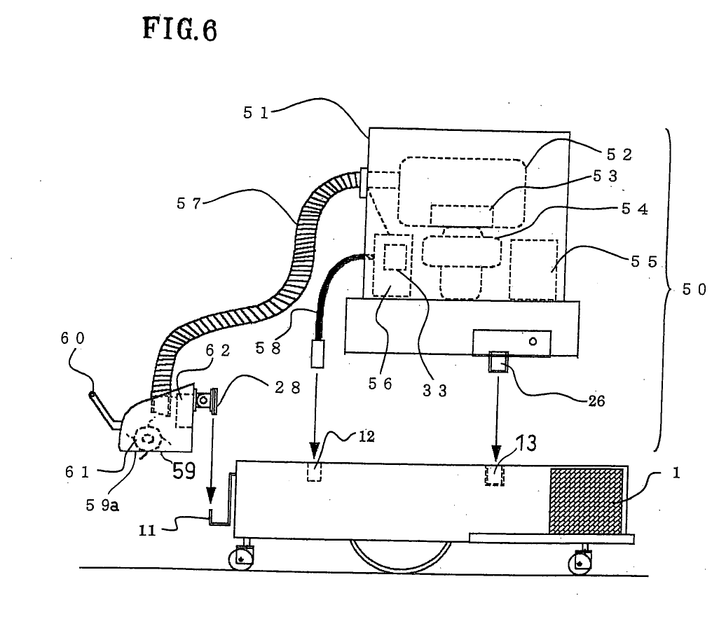

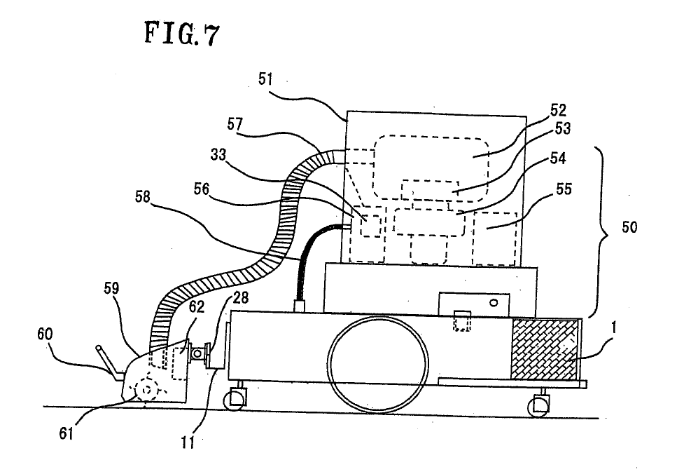

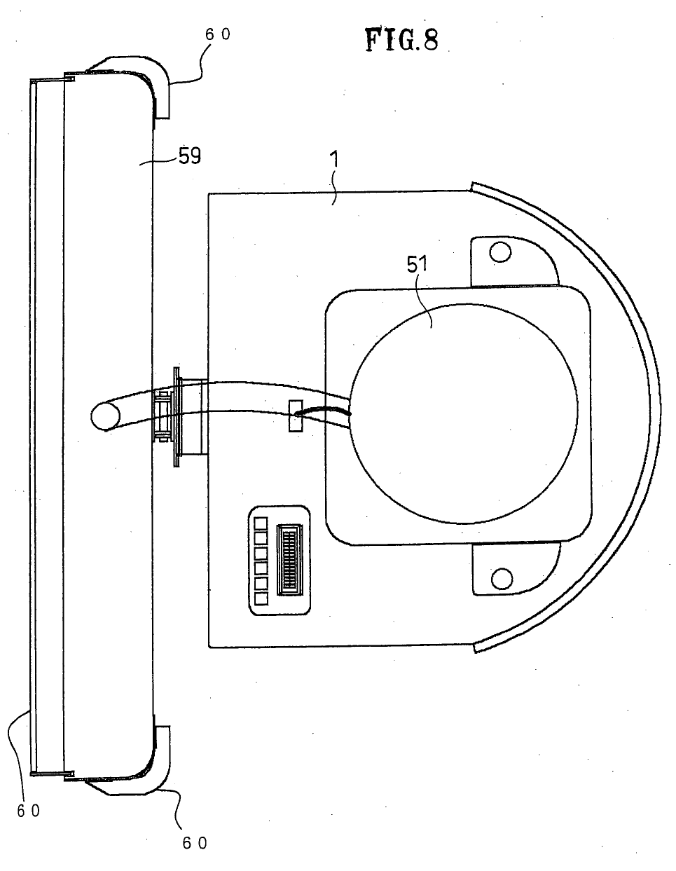

FIG. 6 and FIG. 7 show the state where a sucking and cleaning assembly 50, as the second working assembly, is applied on the traveling assembly 1, in place of the liquid applying assembly (the first work assembly) 20. FIG. 8 is a plan view from above, showing the state the sucking and cleaning assembly 50 is mounted on the traveling assembly 1.

Second Working Assembly:

The sucking and cleaning assembly 50 is a work assembly which sucks dusts on a flat hard floor or a carpeted floor to clean the floor (an example of the second work). The sucking and cleaning assembly 50 has a top unit 50 and a side unit 51. The top unit 50 is a part relatively heavy in weight, including such elements as a dust storage part (a tank) 52, a blower motor 54, a filter 53, a battery 55 and a first control board 56, which need not be placed near the floor. The side unit 59 has a suction port 59a which is located near the floor and which sucks dusts on the floor.

The method of attaching the sucking and cleaning assembly 50 to the traveling assembly 1 is similar to that of attaching the above-mentioned liquid applying assembly 20, and so its detailed explanation is omitted.

Electrical power for actuating the sucking and cleaning assembly 50 may be supplied with electric power for driving the assembly 50 from a power supply (not shown) which is provided in the traveling assembly 1, but it is preferred that a battery 55 for the sucking and cleaning assembly 50 be provided in order to extend the usable time of the sucking and cleaning assembly 50, which requires large amount of electricity to work.

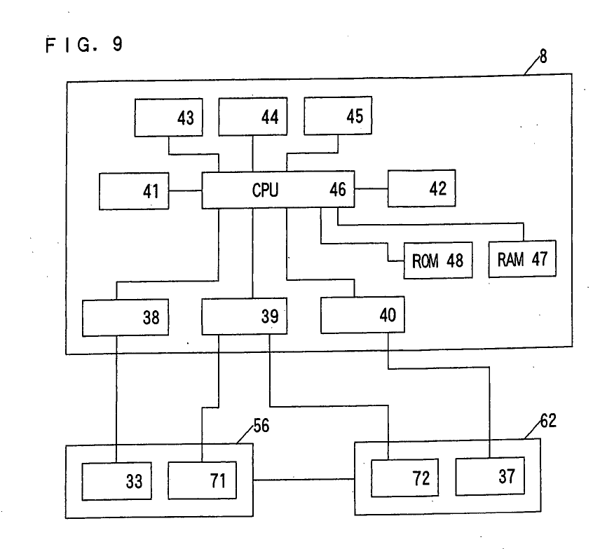

The first control board 56 is provided with the top unit 51. As shown in FIG. 9, a type identification means 33 and a blower motor control means 71 are provided with the first control board 56. The type identification means 33 outputs a numeral value, which indicates a type of the working assembly, to the discriminating means 38 provided in the control part 8 of the traveling assembly, through a cable 58. The blower motor control means 71 controls the drive of the blower motor 54.

As shown in FIG. 7 and FIG. 8, touch sensors 60 for detecting a touch with lateral or rear obstacles and a rotating brush 61 for sweeping dusts on the floor are provided with the side unit 59.

As shown in FIG. 7, the second control board 62 is provided with the side unit 59. As shown in FIG. 9, the second control board 62 has a brush control means 72 and a touch sensor control means 37. The control means 72 and 37 control the rotating brush 61 and the touch sensor 60, respectively. A suction hose 57 connects the top unit 51 and the side unit 59. An electric wire is incorporated in the suction hose 57 and the electric wire connects electrically the first control board 56 and the second electrical board 62. Since the side unit 59 is attached to the slidable attachment plate 11, the side unit 59 can slide from side to side, controlled by the control part 8. The length of the suction hose 57 is set within such a range that the suction nozzle part 59 can slide from side to side.

In this second embodiment, the electric wire (connecting cable) connecting the first control board 56 and the second control board 62 is incorporated in the suction hose 57, but the connecting cable may be provided separately from the suction hose. Further, a connecting cable which connects electrically the second control board 62 and the control part 8 may be provided.

In this embodiment, the top unit 51 is directly mounted on the traveling assembly 1, but the mounting mechanism may be separated from the top unit 51 to constitute an independent holder. That is, similarly to the method of attaching the liquid applying assembly (the first working assembly) 20, in this embodiment, the top unit 51 may be mounted after the holder 25 is attached. In this case, by forming the bottom face of the top unit 51 in the same shape as the shape of the bottom face of the tank 21a, the above mentioned tank holder 25 can be also used for holding the top unit 51, thereby to reduce costs.

When the holder is configured to serve every working assembly, the holder need not be detachable from the traveling assembly 1, and so the holder can be firmly fixed to the traveling assembly 1 or the top face of the traveling assembly can be formed in the shape of the holder. Accordingly, costs can be further reduced.

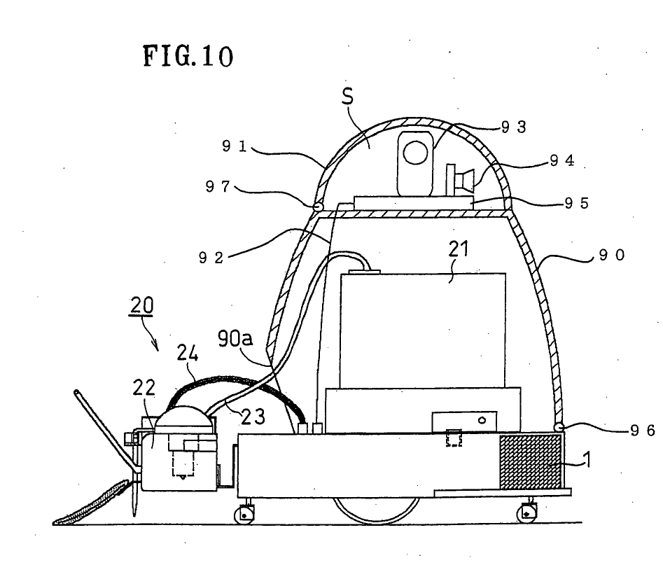

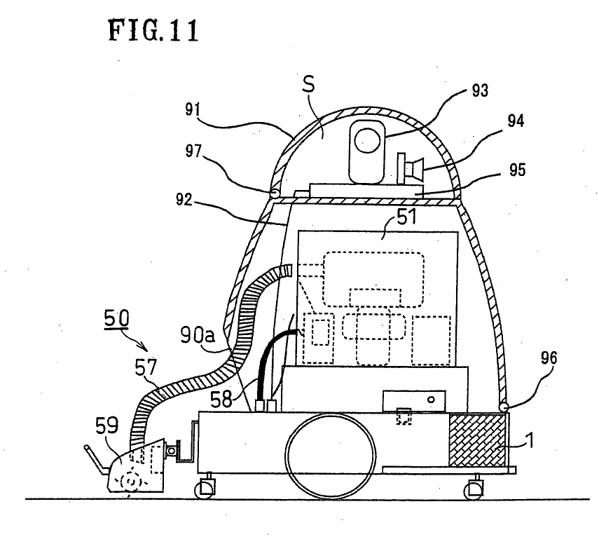

FIG. 10 shows the state where a cover 90 is attached to the traveling assembly 1 on which the liquid applying assembly 20 is mounted. FIG. 11 shows the state where the cover 90 is attached to the traveling assembly on which the sucking and cleaning assembly 50 is mounted.

The cover 90 is of such a size that top unit 21, 51 of the working assemblies 20, 50 on the traveling assembly 1, the connecting cable, the connecting tube and so on can be covered therewith, and is formed in a dome shape. The notched portion 90a is provided on one side of the lower portion of the cover 90. Through the notched portion 90a, the suction hose 57 extending from the side unit 59 of the sucking and cleaning assembly 50, the cable 58, the tube 23 for supplying liquid and the cable 24 extending from the liquid applying assembly 20 pass. The edge part on the other side of the lower portion of the cover 90 is attached to the traveling assembly 1 through a hinge.

A storage space S is provided at a top of the cover 90. In the storage space S, an alarm lamp 93 (an example of alarm), a speaker (another example of alarm) and a alarm control part 95 including a control circuit for the alarm lamp 93 and an electronic speech circuit are stored in the storage space. The alarm control part 95 is connected electrically with the control part 8 of the traveling assembly 1 by an alarm connecting cable 92 and the alarm control part 95 is supplied with electric power from the traveling assembly 1. Further, the alarm control part 95 exchanges control information with the traveling assembly 1 thorough a given communication protocol such as RS232C (recommended standard 232), and controls the alarm to perform alarm operations depending on the situation. For example, when the ultrasonic range finding sensor 3 of the traveling assembly 1 detects an obstacle in the forward, the control part 8 transmits information of detecting the obstacle in the forward to the alarm control part 95 and the alarm control part 95 controls the alarm to generate a voice message for warning of crash from the speaker 94 by voice synthesis.

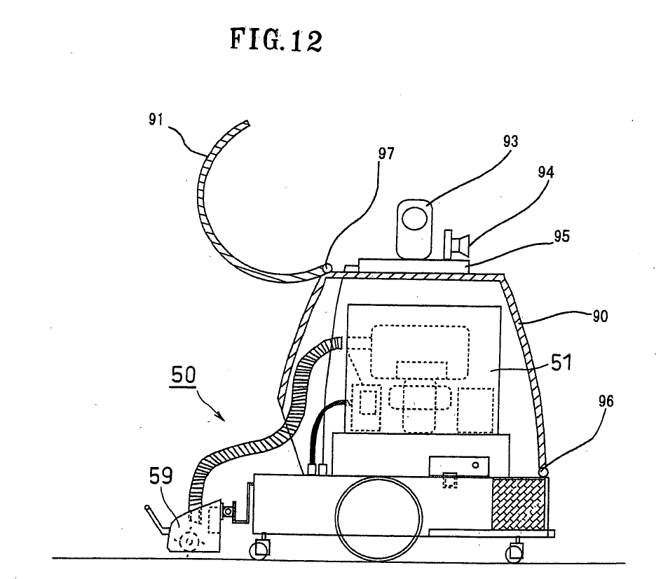

As shown in FIG. 12, the top cover 91 is openably attached to the cover 90 through a hinge 97. Accordingly, it is easy to change the setting of the alarm lamp 93 and to perform the maintenance of the alarm lamp 93 and so on.

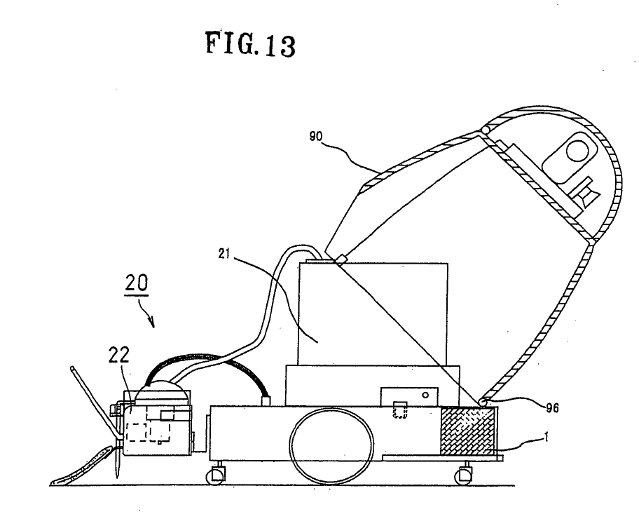

As shown in FIG. 13, when the cover is openably attached to the cover 90 to the traveling assembly 1 through a hinge 96, it is easy to replenish liquid with the tank 21a and to take out dusts collected into the dust storage part 52. When the robot is used to travel at so low speed that the cover won't be displaced even if the cover 90 is merely put on the traveling assembly 1, the hinge 96 may be omitted. In this case, since the cover 90 is easily removed, it becomes easier to replenish liquid with the tank 21a and to take out dusts collected into the dust storage part 52.

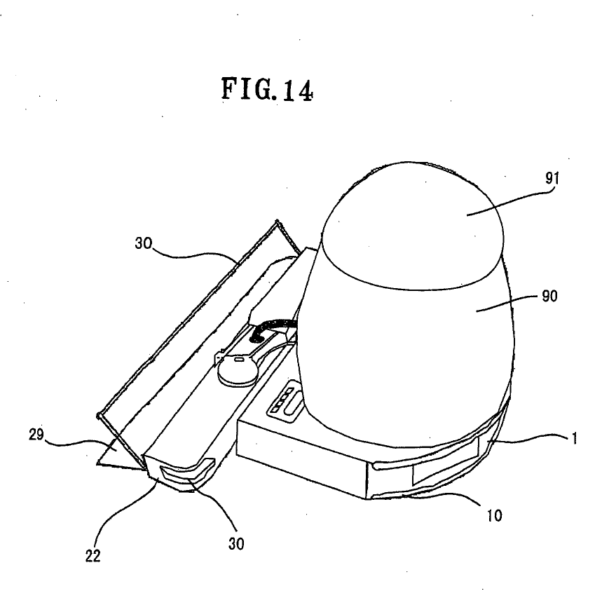

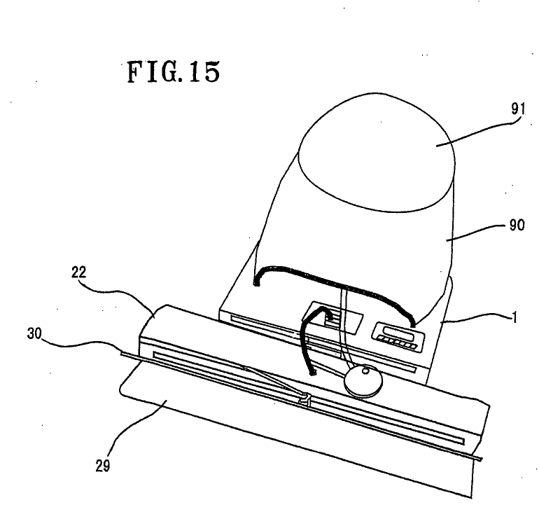

FIG. 14 and FIG. 15 are perspective views showing the state the cover 90 is attached. As shown in both figures, it is easily appreciated that an external appearance of uniform design is obtained independently of a type of the attached working assembly. And the maintenance of each unit can be separately.

Sucking and Cleaning Operation (Cleaning by Sucking Dusts):

Firstly, traveling movement of the working robot 100 during sucking and cleaning operation will be described.

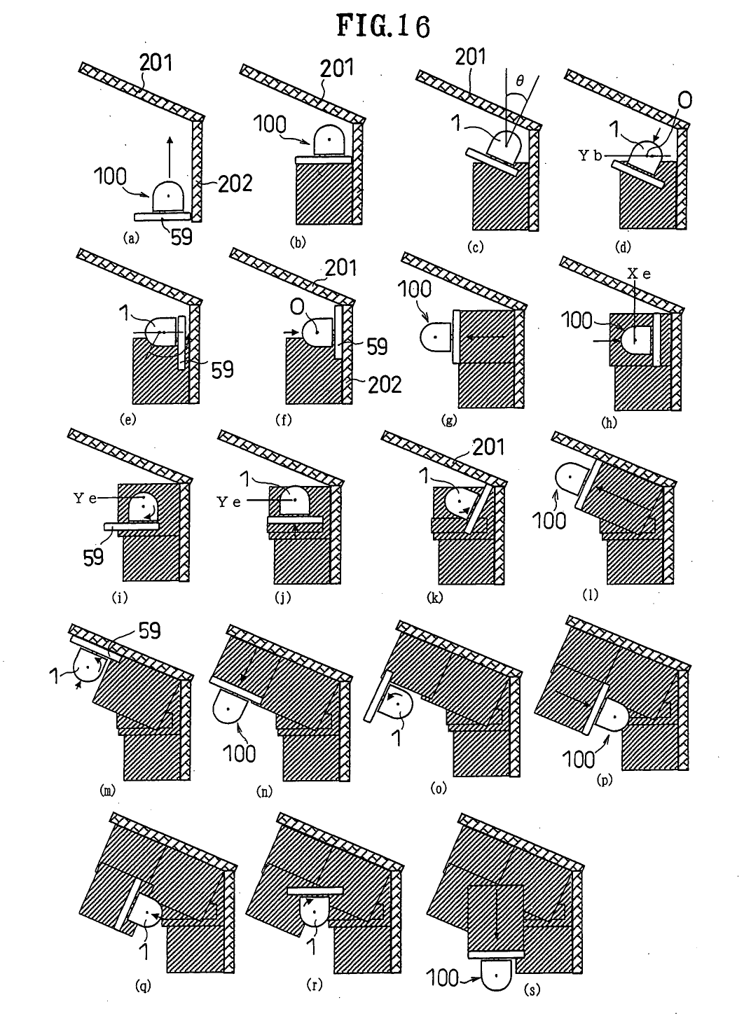

FIG. 16 is a plan view showing an example of traveling movement of the working robot 100 during the sucking and cleaning operation with the sucking and cleaning assembly 50.

As shown in (a) and (b) of FIG. 16, when the sucking and cleaning operation is performed by the sucking and cleaning assembly 50, the traveling assembly 1 mainly travels with the side unit 59 attached in the rear of the drive wheels 6 and auxiliary wheels shown in FIG. 1.

As shown in (a) of FIG. 16, the working robot 100 travels forward along a side wall 202, with the sucking and cleaning operation performed by the side unit 59. During this traveling, the distance between the robot 100 and the side wall 202 is measured and a data of the measured distance and a travel distance at the time of measuring is stored in the RAM 47.

As shown in (b) of FIG. 16, when the sensor detects an obstacle 201 in the forward, the traveling assembly 1 stops traveling. Then, on the basis of the detection value from each sensor, the CPU 46 recognizes that the obstacle 201 in the forward is an askew wall wherein the distance from the left side of the askew wall to the robot 100 is larger than that from the right side of the askew wall to the robot 100 at this time. The CPU 46 also recognizes that the wall 202 exists on the right side of the traveling assembly 1.

Then, since the type of the working assembly is the sucking and cleaning assembly 50 and the askew wall 202 exists in the forward of the robot 1, the CPU (an example of a recognizing means) 46 determines a path where the traveling assembly 1 travels as shown in (c) to (s) of FIG. 16 so that the sucking and cleaning operation is performed in every nook and cranny not to leave an area where the operation is not performed.

That is, as shown in (a) to (s) of FIG. 16, when the sucking and cleaning assembly 50 is mounted on the traveling assembly 1 and the operation of cleaning the floor face by sucking dusts on the floor (the second operation), the CPU 46 determines the path so that the second operation can be performed at an edge area of the floor with the drive wheels 6 and auxiliary wheels (FIG. 1) allowed to pass on an area of the floor where the sucking and cleaning operation has already been performed (the hatched area in FIG. 16). Such determination allows the working robot 100 to clean the floor in every nook and cranny not to leave an area which has not yet cleaned.

Liquid Applying Operation:

Next, traveling movement of the working robot 100 during liquid applying operation will be described.

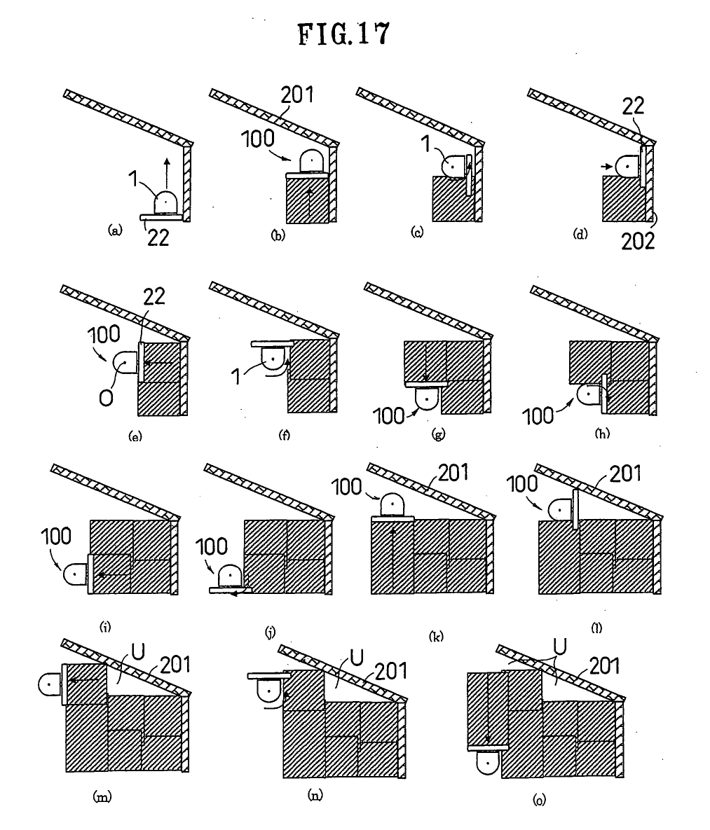

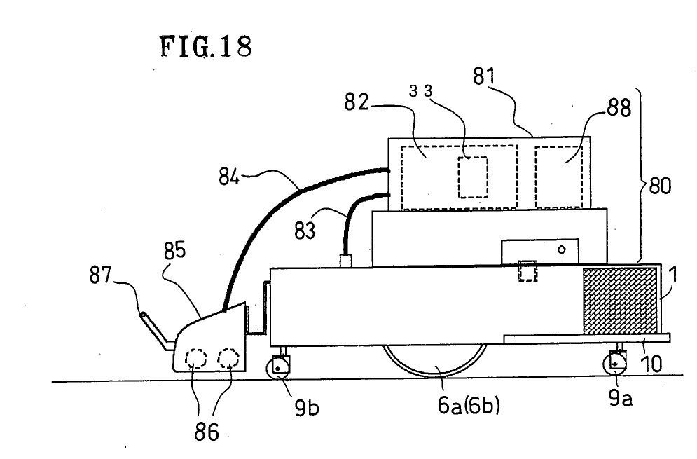

FIG. 17 is a plan view showing an example of traveling movement of the working robot 100 during the liquid applying operation with the liquid applying assembly 50.

As shown in (a) and (b) of FIG. 17, when the liquid applying operation is performed by the sucking and cleaning assembly 50, the traveling assembly 1 mainly travels with an application part (the nozzle 31 and the cloth 29 for spreading liquid), as the side unit 59, attached in the rear of the drive wheels 6 and auxiliary wheels shown in FIG. 1.

As shown in (b) of FIG. 17, when a plurality of sensors detect an obstacle in the forward, since the type of the working assembly is the liquid applying assembly 50 and the obstacle 201 exists in the forward of the robot 1, the CPU (an example of a recognizing means) 46 determines a path where the traveling assembly 1 travels so that the wheels of the traveling assembly 1 do not substantially pass on an area where the liquid applying operation has already been performed, in the way hereinafter prescribed.

That is, as shown in (a) to (o) of FIG. 17, when the liquid applying assembly 20 is mounted on the traveling assembly 1 and the operation of applying the liquid onto the floor face (the first operation), the CPU 46 determines the path so that the drive wheels 6 and auxiliary wheels (FIG. 1) of the traveling assembly 1 do not substantially pass on an already liquid applied area of the floor where the liquid applying operation has already been performed (the hatched area in FIG. 17). Such determination allows the working robot 100 to perform the liquid applying operation so that wheel ruts may not be formed on the already liquid applied area where the liquid has already been applied.

Since a liquid non applied area U is not very large, a worker (human) may apply the liquid onto the liquid non applied area U, afterward.

In the case of drying liquid such as wax that is applied onto the floor face by infrared ray radiation or the case of hardening ray hardening resin that is applied onto the floor face by ultraviolet ray radiation, an radiation operation is performed with a radiation assembly 80 shown in FIG. 18 mounted on the traveling assembly 1.

As shown in FIG. 18, the radiation assembly 80 has a power control part (top unit) 81 including a battery 88 and a control board 82, and an irradiation box (side unit) 85 including a lamp 86 near the floor face for radiating infrared ray or ultraviolet ray to the floor.

The control board 82 is provided with the type identification means 33. The type identification means 33 outputs a numeral value which indicates a type of the working assembly to the discriminating means 38 (FIG. 5(a)) provided in the control part 8 of the traveling assembly 1.

The radiation box 85 is provided with a touch sensor 87 that detects touch with a obstacle. Electric power is supplied to the lamp 86 through a cable 84 connecting the power control part 81 and the radiation box 85 with each other.

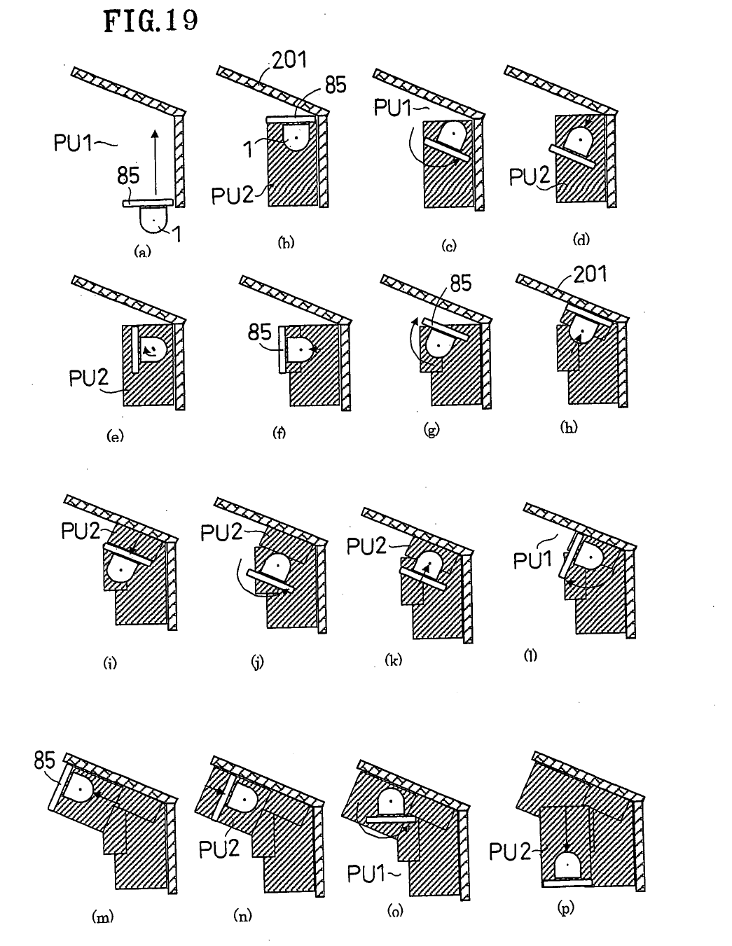

FIG. 19 is a plan view showing an example of traveling movement of the working robot during the radiation operation with the radiation assembly 80. The floor face of FIG. 19 is an already liquid applied area PU1 where ray hardening resin has already been applied. The hatched area of FIG. 19 is an already ray radiated area PU2 where ultraviolet ray has already been radiated by the radiation box 85 of the radiation assembly 80.

As shown in (a) and (b) of FIG. 19, during the radiation operation by the radiation assembly 80, the main traveling direction of the traveling assembly 1 is opposite to the main traveling direction of the traveling assembly 1 shown in FIG. 16 and FIG. 17. That is, the traveling assembly 1 mainly travels with the lamp 86 of the radiation box 85 located in front of the drive wheels 6a, 6b and auxiliary wheels 9a, 9b shown in FIG. 18.

Accordingly, As shown in (b) to (p) of FIG. 19, the traveling assembly 1 travels only on the already ray radiated area PU2 where ray hardening resin has already been hardened by ultraviolet ray radiation from the radiation box 85 of the radiation assembly 80, and the wheels do not substantially pass on the already liquid applied area PU1 where ray hardening resin has already been applied and where ultraviolet ray has not yet radiated. Accordingly, the radiation operation can be performed without forming wheel ruts on the floor face.

During the radiation operation shown in FIG. 19, the traveling assembly 1 travels at lower speed, and so the working robot is unlikely to clash violently. Accordingly, even if the touch sensor 87 (FIG. 18) of the radiation box 85 is located in front of the drive wheel 6 and an obstacle in the forward of the traveling assembly 1 is detected by the touch of the touch sensor 87, the clash with the obstacle can be sufficiently prevented.

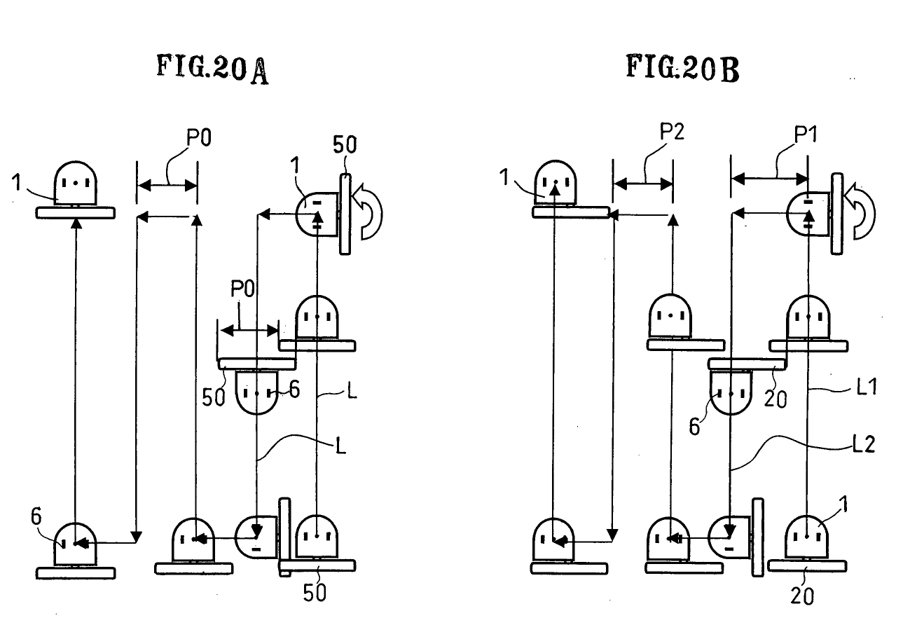

FIG. 20A shows the path along which the working robot travels during the sucking and cleaning operation. FIG. 20B shows the path along which the working robot travels during the liquid applying operation.

As shown in these figures, in the case of cleaning a square-shaped area, after the traveling assembly 1 goes straight in the longitudinal first direction, the traveling assembly 1 turns by 90 degrees and goes straight a little in the transverse direction. And then, the traveling assembly 1 turns by 90 degrees again, and goes straight in the longitudinal second direction. Such traveling movement, where going straight in the longitudinal direction, turning and going straight in the transverse direction are repeated, i.e. moving in a zigzag, enables the operation to be performed in the square area in every nook and cranny.

When the sucking and cleaning operation of FIG. 20A is performed, a pitch P0 of traveling lanes L extending along the longitudinal direction is set approximately constant. This is because there is no problem even if the drive wheels 6 and the like pass on an already cleaned area of the floor where the sucking and cleaning operation has already been performed.

On the other hand, when the liquid applying operation of FIG. 20B is performed, the first pitch P1 between the first traveling lane L1 and the second traveling lane L2 is set larger than the second pitch P2 between other lanes. The reason why the first pitch P1 is set larger than the second pitch P2 is that the floor may become dirty if the drive wheels 6 and the like pass on an area of the floor where the liquid has already been applied.

When the traveling assembly 1 travels along the first traveling lane L1, the liquid applying assembly 20 is not misaligned relative to the traveling assembly 1, in principle, i.e., the center line of the liquid applying assembly 20 approximately coincides with that of the traveling assembly 1. On the other hand, when the traveling assembly 1 along other lanes including the second traveling lane L2, the liquid applying assembly 20 is misaligned toward the lane, on which the traveling assembly exists, relative to the traveling assembly 1, in principle, i.e., the center line of the liquid applying assembly 20 is misaligned with respect to that of the traveling assembly 1.

The pitch P0 at the time of the sucking and cleaning operation shown in FIG. 20A and the pitch P2 (P1) may be different from each other.

As described above, although the preferred embodiments have been described with reference to the drawings, one of ordinary skill in the art could conceive various modifications and corrections within an obvious range by referring to the present specification.

For example, a type of the working assembly may be discriminated by physical method instead of electrical method. Examples of physical methods include, but are not limited to, forming the type identification means by attaching an obstacle plate at a position which differs depending on a type of the working assembly, or detecting the protrusion of the working assembly provided at a position which differs depending on a type of the working assembly.

The working assemblies are not limited to above mentioned two types, and more than three types of the working assemblies including an ultraviolet rays radiation assembly, a radiation dose measuring assembly and so on, can be mounted on the traveling assembly.

### INDUSTRIAL APPLICABILITY

In the working robot of the present invention, various working assemblies can be mounted, including not only a liquid applying assembly and a sucking and cleaning assembly, but also an ultraviolet rays radiation assembly which coats the floor face by radiating ultraviolet rays to the floor where ultraviolet rays hardening resin is applied, a radiation dose measuring assembly which measures radiation dose distribution of the floor of medical facilities or research facilities where radioactive material is dealt with, a glossiness measuring assembly which measures distribution of glossiness of the floor where wax or ultraviolet rays hardening resin is coated and so on, and the working assemblies can be exchanged for each other.

1. A self-propelled working robot comprising:
a traveling assembly having a wheel rotating on a floor;
a first working assembly that performs a first operation with respect to the floor and is detachable from the traveling assembly; and
a second working assembly that performs a second operation with respect to the floor and is detachable from the traveling assembly, wherein
either the first working assembly or the second working assembly is selectively mounted on the traveling assembly,
each working assembly has a type identification means that enables identification of a type of the working assembly when mounted on the traveling assembly, and
the traveling assembly has a driving motor that drives the wheel, a wheel controlling means that controls rotation of the driving motor, a discriminating means that discriminates which of the working assemblies is mounted, based on the type identification means of the mounted working assembly, and a work signal output means that outputs a work signal for actuating the mounted working assembly according to the type of the mounted working assembly in response to a result of a discrimination of the discriminating means.

2. A self-propelled working robot according to claim 1, wherein
the type identification means outputs an electrical signal for identification of the type of the working assembly to the discriminating means.

3. A self-propelled working robot according to claim 2, wherein
each working assembly is equipped with a control board that controls operation of the working assembly based on the work signal from the traveling assembly.

4. A self-propelled working robot according to claim 1, wherein
the traveling assembly is a carriage supported by the wheel, and
each working assembly comprises:
a side unit that is attached to a fore side or a rear side of the carriage and is in proximity to or in contact with the floor;
a top unit including a tank mounted on a top surface of the carriage; and
a tube that connects both units with each other.

5. A self-propelled working robot according to claim 4, wherein
a cover covering the top unit in a state where the top unit is mounted on the traveling assembly is detachably provided on the carriage of the traveling assembly.

6. A self-propelled working robot according to claim 5, wherein
a storage space is provided in a top of the cover and an alarm is stored in the storage space.

7. A self-propelled working robot according to claim 4, wherein
a tank of the top unit of the first assembly stores liquid therein,
the side unit of the first working assembly includes a applying part that applies the liquid,
the side unit of the second working assembly includes a suction port that sucks dusts on the floor, and
the dusts are accumulated in the tank of the top unit of the second assembly.

8. A self-propelled working robot according to claim 4, wherein
the traveling assembly further comprises an attachment plate that slides from side to side along a slide rail, and
each working assembly further comprises an attachment fitting engaged in the attachment plate to attach the side unit to the traveling assembly.

9. A self-propelled working robot comprising:
a traveling assembly having a wheel and self-propelled on a floor;
a first working assembly that performs a first operation with respect to the floor and is detachable from the traveling assembly; and
a second working assembly that performs a second operation with respect to the floor and is detachable from the traveling assembly, wherein
either the first working assembly or the second working assembly is selectively mounted on the traveling assembly
the traveling assembly comprises: a driving motor for driving the wheel; a plurality of detecting means that detect a obstacle; a recognizing means that recognizes a state of the obstacle, based on an output from the detecting means; a determining means that determines a path where the working robot travels, according to a type of the mounted working assembly and the state of the obstacle recognized by the recognizing means; and a wheel controlling means that controls rotation of the driving motor so that the working robot travels along the path determined by the determining means, and
each working assembly comprises a type identification means that enables identification of the type of the working assembly when mounted on the traveling assembly, and the traveling assembly further comprises a discriminating means that discriminates which of the working assemblies is mounted.

10. A self-propelled working robot comprising:
a traveling assembly having a wheel and self-propelled on a floor;
a first working assembly that performs a first operation with respect to the floor and is detachable from the traveling assembly; and
a second working assembly that performs a second operation with respect to the floor and is detachable from the traveling assembly, wherein
either the first working assembly or the second working assembly is selectively mounted on the traveling assembly and
the traveling assembly comprises: a driving motor for driving the wheel; a plurality of detecting means that detects a obstacle; a recognizing means that recognizes a state of the obstacle, based on an output from the detecting means; a determining means that determines a path where the working robot travels, according to the type of the mounted working assembly and the state of the obstacle recognized by the recognizing means; and a wheel controlling means that controls rotation of the driving motor so that the working robot travels along the path determined by the determining means.

11. A self-propelled working robot according to claim 10, wherein
when the working robot performs the first operation, the determining means determines the path so that the wheel does not substantially pass on an area of the floor where the first operation has already been performed and
when the working robot performs the second operation, the determining means determines the path so that the second operation can be performed at an edge area of the floor with the wheel allowed to pass on an area of the floor where the second operation has already been performed.
